(19) United States
(12) Patent Application Publication
(10) Pub. No.: US 2009/0242586 A1
(43) Pub. Date: Oct. 1, 2009

(54) WATER INTAKE SAFEGUARD FOR BOTTLED WATER DISPENSERS

(76) Inventor: George M. Yui, Toronto (CA)

Correspondence Address: HPF, P.O. BOX 4442, CHESTERFIELD, MO, 63006-4442, US

(21) Appl. No.: 12/397,688

(22) Filed: Mar. 4, 2009

(30) Foreign Application Priority Data
Mar. 4, 2008 (CN) 2008-20083867

(51) Int. Cl. B67D 5/08; B67D 5/62

(52) U.S. Cl. 222/67; 222/146.1

(57) ABSTRACT

Devices and methods for dispensing bottled water are provided. More particularly, devices and methods for preventing water from overflowing out of bottled water coolers are provided. According to certain embodiments, a bottled water dispenser is provided which comprises: (1) a water bottle; (2) a pump; (3) a control unit which instructs the pump to inject air into the water bottle (or, under certain circumstances, to cease injecting air into the water bottle); (4) a cold tank that receives water from the water bottle through an inlet tube and one-way valve; and (5) a baffle disposed within the cold tank. The invention provides that upon a volume of water within the cold tank exceeding a threshold level, a surface of the water contacts and exerts a force on the baffle, which causes the baffle and the one-way valve to close the inlet tube.

### CROSS-REFERENCE TO RELATED APPLICATIONS

This application claims priority to, and incorporates by reference, Chinese Patent Application Number 2008-20083867, filed Mar. 4, 2008, under 35 U.S.C. § 119(a).

### FIELD OF THE INVENTION

The present invention relates generally to the field of bottled water dispensers and, more particularly, to devices and methods for preventing water from overflowing out of bottled water dispensers.

### BACKGROUND OF THE INVENTION

The demand for clean and healthy drinking water is increasing dramatically, which is being driven by the rapid growth in population and standards of living across the globe. This demand has translated into a continuing need for safe, clean, and easy to use water dispensers, including for both hot and cold water. Many of the currently-available water dispensers include a cold tank that receives water from a water bottle, such that the cold tank may cool the water prior to being dispensed and consumed by a user.

Under certain circumstances, too much water is transferred from the water bottle to the cold tank, and/or the water is transferred from the water bottle to the cold tank at an undesirably fast rate, which causes water to exceed certain threshold volumes within the cold tank, leading to spills or water being ejected from the cold tank. For example, in certain water dispensers, water may be transferred from a water bottle into a cold tank vis-à-vis air pressure. Many water bottles are made of relatively thin plastic, such that the water bottle expands or contracts when air is injected into or extracted from the water bottle, respectively. In certain cases, when air is injected into a water bottle, to transfer water to a cold tank (causing the bottle to expand), and when the air injection is subsequently terminated and air is allowed to leave the water bottle (causing the air pressure to drop and the bottle to contract), the contraction of the water bottle will push additional water into the cold tank. In some cases, this additional water will cause the cold tank to overflow, which may lead to spills or water being ejected from the cold tank.

As the following will demonstrate, many of the foregoing problems with currently-available water dispensers are addressed by the present invention.

### SUMMARY OF THE INVENTION

According to certain aspects of the invention, devices and methods for preventing water from overflowing out of bottled water dispensers are provided. According to such embodiments, a bottled water dispenser is provided which comprises: (1) a water bottle; (2) a pump; (3) a control unit which instructs the pump to inject air into the water bottle (or, under certain circumstances described herein, to cease injecting air into the water bottle); (4) a cold tank that receives water from the water bottle through an inlet tube and one-way valve; and (5) a baffle disposed within the cold tank. The invention provides that upon a volume of water within the cold tank exceeding a threshold level, a surface of the water contacts and exerts an upwards force on the baffle, which causes the baffle and the one-way valve to close the inlet tube, thereby stopping the flow of water from the water bottle into the cold tank.

According to certain embodiments, the invention provides that the bottled water dispenser may further comprise one or more posts disposed near a top, interior surface of the cold tank—in a location that is, preferably, opposite from the inlet tube. In certain preferred embodiments, the one or more posts will comprise a length that is greater than a length of the one-way valve. Still further, in certain embodiments of the invention, the baffle is circular and includes a convex circular area (or line) located on a top surface of the baffle which faces the one-way valve and the one or more posts. The invention provides that upon the volume of water within the cold tank exceeding a threshold level, the baffle is forced upwards such that a first side of the convex circular area (of the baffle) will contact the one or more posts, which causes the baffle to tilt such that a second side of the convex circular area moves towards, and causes the one-way valve to close, the inlet tube.

Still further, according to certain embodiments, the bottled water dispensers will comprise a buoyant float (baffle) disposed within the cold tank, such as within or close to the middle portion thereof. More particularly, the buoyant float may rest on the surface of the water contained within the cold tank, such that upon the volume of water within the cold tank exceeding the threshold level mentioned above, the float is forced upwards (relative to the bottom surface of the cold tank) by the water and activates an electromagnetic switch. The activation of the electromagnetic switch, in turn, causes the control unit to instruct the pump to cease injecting air into the water bottle.

Accordingly, when the water within the cold tank exceeds a threshold level, (1) the buoyant float rises and activates the electromagnetic switch, thereby causing the control unit to instruct the pump to stop injecting air into the water bottle; and (2) the water level forces the baffle to move towards, and cause the one-way valve to close, the inlet tube. Both mechanisms, in combination, serve to terminate the flow of water from the water bottle into the cold tank, including any water that may otherwise have been ejected from the water bottle and into the cold tank when the body of the water bottle compresses (i.e., when the air pressure drops as a result of the pump ceasing to inject air into the water bottle).

The above-mentioned and additional features of the present invention are further illustrated in the Detailed Description contained herein.

### BRIEF DESCRIPTION OF THE FIGURES

FIG. 1: A cross-sectional, side view of a top portion of the cold tank described herein.

FIG. 2: A magnified cross-sectional, side view of a top portion of the cold tank described herein, showing the one-way valve in a closed position, such that water may not be dispensed into the cold tank from the inlet tube.

FIG. 3: A magnified cross-sectional, side view of a top portion of the cold tank described herein, showing the one-way valve in an open position, such that water may be dispensed into the cold tank from the inlet tube.

FIG. 4: A perspective view of a cold tank cover, which shows the top, interior surface of the cold tank.

FIG. 5: A perspective view of the baffle described herein.

FIG. 6: A cross-sectional, side view of the water bottle, cold tank, and hot tank described herein.

FIG. 7: A cross-sectional, side view of a top portion of the cold tank described herein, which does not include the one or more posts described herein.

FIG. 8: A cross-sectional, side view of the cold tank of FIG. 7, which does not show a desirably tight fit between the one-way valve and the inlet tube, such that water is allowed to leak from the inlet tube and into the cold tank.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

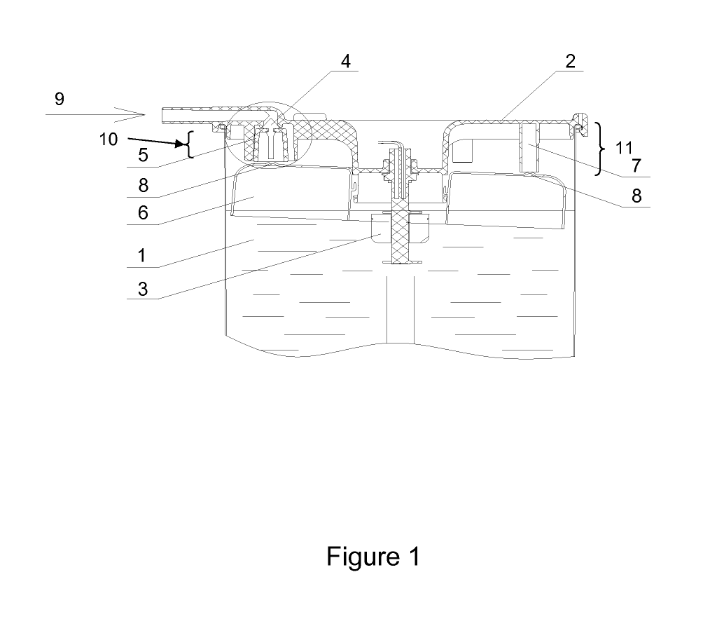

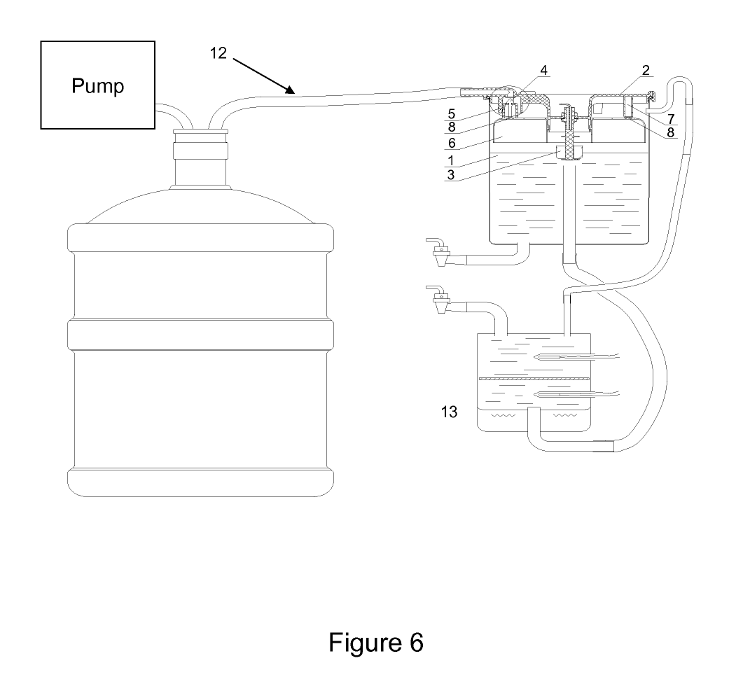

According to certain aspects of the invention, devices and methods for preventing water from overflowing out of bottled water dispensers are provided. Referring to FIGS. 1-6, according to certain embodiments, a bottled water dispenser is provided which comprises a water bottle (FIG. 6), a pump, and a control unit which instructs the pump to inject air into the water bottle (or, under certain circumstances described herein, to cease injecting air into the water bottle). Preferably, the pump will inject air into the water bottle at defined and periodic intervals. For example, the pump may be instructed, by the control unit, to inject air into the water bottle for 4 seconds, to cease the injection of air into the bottle for 10 seconds, and then to continuously repeat the foregoing steps. The invention provides that the foregoing method of injecting air into the water bottle represents a preferred means for “priming” the water bottle, such that water is transferred therefrom at a desirable rate.

The bottled water dispensers further include a cold tank 1, with a cold tank cover 2 located near the top portion thereof. The cold tank 1 receives water from the water bottle through an inlet tube (9, FIG. 1). The cold tank 1 will preferably comprise a means for cooling or chilling the water contained therein, such as by incorporating the use of heat sinks (evaporators) or circulating coolants (refrigerant gasses) along the surfaces thereof. A non-limiting example of such a refrigerant gas includes 134a (tetrafluoroethane). FIG. 6 shows a tube 12, with a first end thereof being disposed near the bottom of the water bottle (not shown), which leaves the narrow neck portion of the water bottle and travels to and connects with the cold tank 1, such that the tube is contiguous with (or forms a part of) the inlet tube 9. FIG. 6 illustrates that, in certain embodiments, the bottled water dispensers may further include a hot water tank 13, which includes a means for heating the water contained therein, such as heating coils or other electric heating elements.

According to certain embodiments, the bottled water dispensers will comprise a buoyant float (or baffle) 3 disposed within the cold tank 1, preferably within or close to the middle portion thereof. More particularly, the buoyant float (or baffle) 3 may rest on the surface of the water contained within the cold tank 1, such that upon the volume of water within the cold tank 1 exceeding a threshold level, the float (or baffle) 3 is forced upwards (relative to the bottom surface of the cold tank 1) by the water and activates an electromagnetic switch. The activation of the electromagnetic switch, in turn, causes the control unit to instruct the pump to cease injecting air into the water bottle, i.e., to terminate the periodic injection of air into the water bottle, as described above. The lack of air being injected into the water bottle serves to terminate the flow of water from the water bottle and into the cold tank 1.

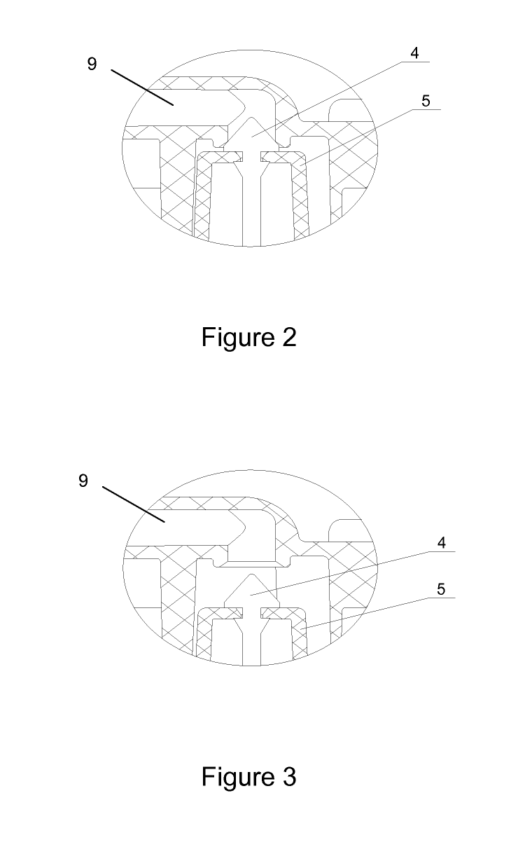

Referring to FIGS. 1-3, the bottled water dispensers further comprise a one-way valve 4, which is adapted to reversibly plug (and unplug) the inlet tube 9. More particularly, the one-way valve may comprise an inlet tube plug (shown as element 4 in FIGS. 2 and 3), and a holder 5 which is adapted to position the inlet tube plug (one-way valve) 4 near the opening of the inlet tube 9, such that the inlet tube plug (one-way valve) 4 may be reversibly forced into the inlet tube (to prevent the flow of water therefrom and into the cold tank 1). In addition, the bottled water dispensers comprise a baffle 6 disposed within the cold tank 1. Referring to FIGS. 1 and 2, the invention provides that upon a volume of water within the cold tank 1 exceeding a threshold level, the surface of the water contacts and exerts an upwards force on the baffle 6, which causes the baffle 6 and the one-way valve 4 to move upwards and plug (and close) the inlet tube 9, thereby stopping the flow of water from the water bottle into the cold tank 1. When the water level subsides below the threshold level, such as the result of a user dispensing a sufficient amount of water from the bottled water dispenser, the water will no longer exert such a force on the baffle 6, such that the baffle 6 and one-way valve 4 drop away from, unplug, and open the inlet tube 9 (FIG. 3). Likewise, when the water level subsides below the threshold level, the float (or baffle) 3 moves downwards (towards the bottom surface of the cold tank 1) along with the water level, which deactivates the electromagnetic switch. Upon the deactivation of the electromagnetic switch, the control unit will instruct the pump to resume injecting air into the water bottle, preferably in accordance with the periodic injection of air described above.

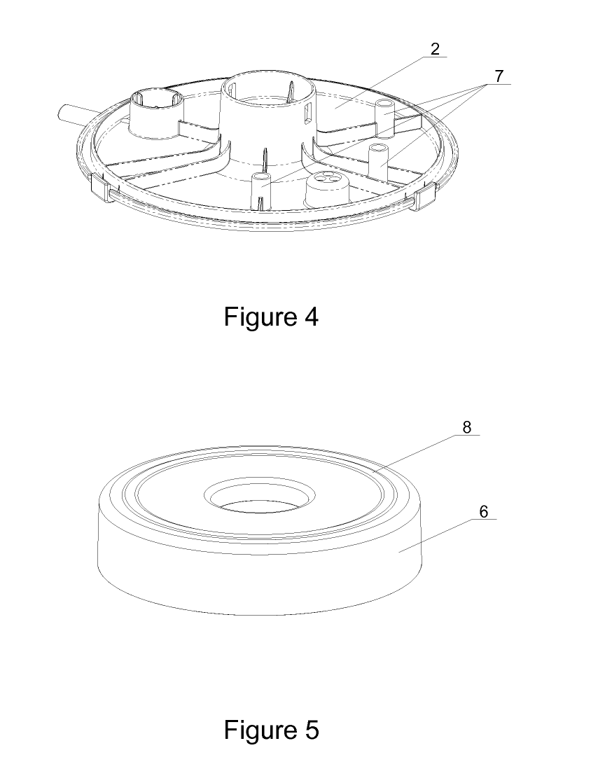

According to certain embodiments, the invention provides that the bottled water dispenser may further comprise one or more posts 7 disposed near a top, interior surface of the cold tank 1, such as on the interior surface of the cold tank cover 2 (FIG. 4). Preferably, the one or more posts 7 are located on the opposite side of the cold tank 1, relative to the location of the inlet tube 9. The cold tank cover 2 shown in FIG. 4 includes three separate posts 7, which are spaced 60-degrees apart from each other (relative to the center point of the cold tank cover 2). In certain embodiments, all of the posts 7 will exhibit the same length 11; whereas, in other embodiments, the middle (of three) posts 7 will exhibit a greater length 11 than the other two posts 7 on each side of the center post 7. Referring to FIG. 1, in certain preferred embodiments, the one or more posts 7 will comprise a length 11 that is greater than a length 10 of the one-way valve 4 (and the holder 5 thereof). Referring now to FIG. 5, in certain embodiments of the invention, the baffle 6 is preferably circular and includes a convex circular area (or line) 8 located on a top surface of the baffle 6, which faces the one-way valve 4 and the one or more posts 7. The invention provides that upon the volume of water within the cold tank 1 exceeding a threshold level, a first side of the convex circular area 8 will contact the one or more posts 7, which causes the baffle 6 to tilt such that a second side of the convex circular area 8 moves towards, and causes the one-way valve 4 to close, the inlet tube 9. The tilted baffle 6 is illustrated in FIG. 1.

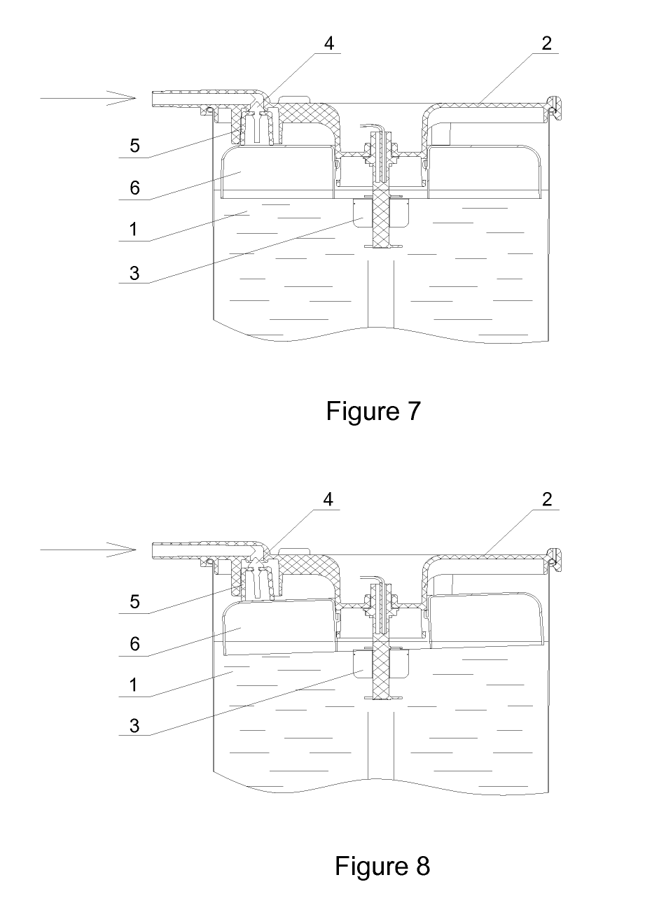

FIG. 7 shows a cross-sectional, side view of a top portion of a cold tank 1 described herein, which does not include the one or more posts 7 described above. In FIG. 7, the water level has exceeded the set threshold, such that the baffle 6 and one-way valve 4 have moved towards and closed the inlet tube 9. However, the inventor has found that such configuration, in certain instances, may leave the position of the baffle 6 unstable, such that the one-way valve 4 may become easily dislodged from the inlet tube 9 at times when it should not (e.g., when the water level remains above the set threshold). When this occurs, as illustrated in FIG. 8, water may leak from the inlet tube 9 and into the cold tank 1, such as when the water is ejected from the water bottle when it compresses—upon the drop in the air pressure therein (when the pump ceases to inject air therein), as described above.

Accordingly, as illustrated in FIG. 1, the invention provides that (1) by including one or more posts 7 disposed near a top, interior surface of the cold tank 1, such as on the interior surface of the cold tank cover 2 (FIG. 4), and preferably on the opposite side of the cold tank 1 (relative to the location of the inlet tube 9) and (2) by configuring the one or more posts 7 to be comprise a length 11 that is greater than a length 10 of the one-way valve 4 (and the holder 5 thereof), when the water level exceeds the set threshold and causes the first side of the convex circular area 8 to contact the one or more posts 7, the baffle 6 will tilt such that the second side of the convex circular area 8 moves towards, and causes the one-way valve 4 to close, the inlet tube 9. This preferred configuration has been found to stably keep the inlet tube 9 plugged for the desired period of time (i.e., for so long as the water level exceeds the set threshold), with the one-way valve 4 being considerably less likely to becoming prematurely dislodged from the inlet tube 9.

In view of the foregoing, the invention provides that when the water within the cold tank 1 exceeds a threshold level, (1) the buoyant float (baffle) 3 rises and activates the electromagnetic switch, thereby causing the control unit to instruct the pump to stop injecting air into the water bottle; and (2) the water level forces the baffle 6 to move towards, and cause the one-way valve 4 to close, the inlet tube 9. Both mechanisms, in combination, serve to terminate the flow of water from the water bottle into the cold tank 1, including any water that may otherwise have been ejected from the water bottle and into the cold tank 1 when the body of the water bottle compresses (i.e., when the air pressure drops as a result of the pump ceasing to inject air into the water bottle).

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water dispenser, which comprises:
(a) a water bottle;
(b) a pump;
(c) a control unit which instructs the pump (i) to inject air into the water bottle or (ii) to cease injecting air into the water bottle;
(d) a cold tank, which receives water from the water bottle through an inlet tube and one-way valve; and
(e) a baffle disposed within the cold tank, wherein upon a volume of water within the cold tank exceeding a threshold level, a surface of the water contacts and exerts a force on the baffle, which causes the baffle and the one-way valve to close the inlet tube.

2. The bottled water dispenser of claim 1, which further comprises a buoyant float which rests on the surface of the water contained in the cold tank, wherein upon the volume of water within the cold tank exceeding the threshold level, the buoyant float is forced upwards, relative to a bottom surface of the cold tank, by the water and activates an electromagnetic switch which causes the control unit to instruct the pump to cease injecting air into the water bottle.

3. The bottled water dispenser of claim 2, which further includes one or more posts disposed near a top, interior surface of the cold tank, wherein the one or more posts comprise a length that is greater than a length of the one-way valve.

4. The bottled water dispenser of claim 3, wherein the one-way valve comprises an inlet tube plug and a holder.

5. The bottled water dispenser of claim 4, wherein the one-way valve is affixed to the baffle.

6. The bottled water dispenser of claim 4, wherein the one-way valve (a) is affixed to the top, interior surface of the cold tank and (b) moves up-and-down along a central axis of the one-way valve.

7. The bottled water dispenser of claim 4, wherein the baffle is circular and comprises a convex circular area located on a top surface of the baffle which faces the one-way valve and one or more posts, wherein upon the volume of water within the cold tank exceeding the threshold level, a first side of the convex circular area contacts the one or more posts which causes the baffle to tilt such that a second side of the convex circular area moves towards, and causes the one-way valve to close, the inlet tube.

8. The bottled water dispenser of claim 4, which further comprises a hot tank.

9. A bottled water dispenser, which comprises:
(a) a water bottle;
(b) a pump;
(c) a control unit which instructs the pump (i) to inject air into the water bottle or (ii) to cease injecting air into the water bottle;
(d) a cold tank, which receives water from the water bottle through an inlet tube and one-way valve;
(e) one or more posts disposed near a top, interior surface of the cold tank, wherein the one or more posts comprise a length that is greater than a length of the one-way valve;
(f) a baffle disposed within the cold tank, wherein:
(i) upon a volume of water within the cold tank exceeding a threshold level, a surface of the water contacts and exerts a force on the baffle, which causes the baffle and the one-way valve to close the inlet tube; and
(ii) the baffle is circular and comprises a convex circular area located on a top surface of the baffle which faces the one-way valve and one or more posts, wherein upon the volume of water within the cold tank exceeding the threshold level, a first side of the convex circular area contacts the one or more posts which causes the baffle to tilt such that a second side of the convex circular area moves towards, and causes the one-way valve to close, the inlet tube; and
(g) a buoyant float which rests on the surface of the water contained in the cold tank, wherein upon the volume of water within the cold tank exceeding the threshold level, the buoyant float is forced upwards, relative to a bottom surface of the cold tank, by the water and activates an electromagnetic switch which causes the control unit to instruct the pump to cease injecting air into the water bottle.
